(19) United States
(12) Patent Application Publication
(10) Pub. No.: US 2015/0168352 A1
(43) Pub. Date: Jun. 18, 2015

(54) LASER ULTRASONIC IMAGING SYSTEM FOR A ROTATING OBJECT AND METHOD THEREOF

(71) Applicant: KOREA ADVANCED INSTITUTE OF SCIENCE AND TECHNOLOGY, Daejeon (KR)

(72) Inventors: Hoon Sohn, Daejeon (KR); Byeong Jin Park, Daejeon (KR)

(73) Assignee: KOREA ADVANCED INSTITUTE OF SCIENCE AND TECHNOLOGY, Daejeon (KR)

(21) Appl. No.: 14/418,427

(22) PCT Filed: Jul. 11, 2013
(86) PCT No.: PCT/KR2013/006195

§ 371 Date: Jan. 29, 2015

(30) Foreign Application Priority Data
Aug. 1, 2012 (KR) 10-2012-0084325

(51) Int. Cl. G01N 29/04; G01M 7/00; G01N 29/24

(52) U.S. Cl. CPC G01N 29/04; G01N 29/2418; G01M 7/00; G01N 2291/023; G01N 2291/0289

(57) ABSTRACT

Provided is a structural health monitoring system of a rotating object such as a turbine blade, which gives easy and intuitive information to field managers on the damage location and the damage size of the rotating object by computing and visualizing correlations between damage and propagating ultrasonic wave. The structural health monitoring system for a rotating object comprises an ultrasonic generation system which generates an ultrasonic signal by irradiating a pulse laser beam to a point of the rotating object, a pulse laser control system which adjusts the irradiating time of the pulse laser beam, an ultrasonic measurement system which measures a generated ultrasonic signal at a point of the rotating object away from the point irradiated by the pulse laser beam and a damage detection system which provides information of damage existence, damage location and damage severity by visualization of monitored ultrasonic signals.

### TECHNICAL FIELD

The present invention relates to a laser ultrasonic imaging system for a rotating object, more specifically to an intuitive health monitoring system and method that detects various local damages of rotating turbine blades using a structural health monitoring system based on the laser ultrasonic.

### BACKGROUND ART

The present invention is supported by the New & Reliable Energy Program (20123030020010) of the Korea Institute of Energy Technology Evaluation and Planning (KETEP) Grant funded by Ministry of Trade, Industry and Energy (MOTIE) and EEWS-2 Program (N01140045) funded by KAIST.

Recently the heavy dependence on fossil energy resource results in energy crisis over the world. Although nuclear power generation has been made an attention as a solution which overcomes the overdependence on fossil energy, it has been increasing safety problems due to several accidents such as the Chernobyl nuclear accident in Ukraine, the Fukushima nuclear accident in Japan, and the Marcoule nuclear accident in France, etc.

As an alternative, many countries in the world make an effort to develop green energy resources such as solar power generation, hydrogen energy, wind power generation, etc. Especially the wind power generation is considered as one of the preferred choices due to its low cost and large scale power generation capability.

Thanks to these advantages, the wind turbine constructions have been expanded actively. However, the study of the structural health monitoring technique of rotating objects in real-time operation, which detects the damage of the wind turbine and obtains the reliability of it, is not enough yet. Especially, since wind turbine blades is easy to get damages by collision with foreign objects from outside, by fatigue from a gust of wind, or by lightning, an early detection of damages is very important for the structural health maintenance and the efficient power generation.

In a previous invention, the structural health monitoring and diagnosis technique of a rotating blade was suggested based on an optical fiber sensor in the non-patent reference 1. The technique in the non-patent reference 1 uses the change of the wavelength of a reflected light according to the change of lattice by deformation of an optical fiber sensor and analyzes the change rate of deformation and the applied weight at an optical sensor position. However, it needs not only very complex data analysis process for the diagnosis of damage and the calculation of the change rate information from the measured wavelength change, but also the manufacturing process that inserts an optical fiber sensor into a blade.

The non-patent reference 2 is related to the blade monitoring technique of a wind turbine blade using an acoustic sensor. The technique detects an acoustic wave emission from the released stress caused by the crack or impact damage. The technique is easy to detect an acoustic wave emission immediately at the time when the damage is caused and to find the damaged location by analyzing the form and the propagating time of acoustic wave. However, it is not easy to analyze acoustic signals due to weak signal and high signal to noise ratio (SNR) and the detecting freedom of the passive monitoring technique also is low, comparing to other active monitoring technique.

The previous inventions require a lot of sensors to achieve high damage detection sensitivity. However, the deployment of many sensors and associated cabling leads to additional installation and maintenance cost caused by the decreased system reliability, and the difficulty of high density sensor network formation caused by the limitation of sensor numbers.

The monitoring system of a rotating object such as a blade of wind power generator and propellers of helicopters, airplanes, and ship engines requires the damage measurement technique with high density and high resolution with even decreasing the number of embedded sensors, and the structural health monitoring system has to be easy and to provide intuitive damage analysis for field maintenance people.

### PRIOR ART REFERENCES

(The non-patent reference 1) Schroeder, K., et al. “A fiber Bragg grating sensor system monitors operational load in a wind turbine rotor blade”, Meas. Sci. Technol. 17, 1167 (2006).
(The non-patent reference 2) Blanch, M. J. and Dutton, A. G., “Acoustic monitoring of field tests of an operating wind turbine”, Key Eng. Mater. 245-246, 475-482(2003).

### DISCLOSURE

### Technical Problem

The present invention is to provide a structural health monitoring system for real time operations which has high field applicability for the intuitive safety monitoring with the prompt and accurate response in the detection of local damages of a rotating object.

### Technical Solution

In order to solve the above problems, a structural health monitoring system of a rotating object according to the present invention comprises, an ultrasonic generation system generating an ultrasonic signal by irradiating a pulse laser beam to a point of the rotating object, a pulse laser control system adjusting the irradiating time of the pulse laser beam, an ultrasonic measurement system measuring a generated ultrasonic signal at a position away from the ultrasonic generation position of the rotating object and a damage detection system providing damage existence, the damage location and the damage severity by visualization of measured ultrasonic signals.

For a preferred embodiment of the present invention, the ultrasonic generation system includes an Nd-YAG pulse laser and a galvanometer for an exact position alignment of laser beam at a position where a laser beam is targeted and for the energy density adjustment of the laser beam.

For a preferred embodiment of the present invention, the ultrasonic measurement system comprises an ultrasonic sensor measuring ultrasonic signals and a digitizer collecting and saving signals, where the ultrasonic sensor may be an embedded sensor such as high sensitivity piezoelectric sensor, a wireless piezoelectric sensor node, or a noncontact measurement instrument such as a laser interferometer.

For a preferred embodiment of the present invention, the pulse laser control system includes an encoder which detects the initial position by generating electric pulse whenever the object rotates one round.

For a preferred embodiment of the present invention, the damage detection system includes an ultrasonic imaging processing unit which performs the image processing of obtained ultrasonic data and an automated damage detection unit which provides information such as the damage existence, the damage location and the damage severity of the rotating object.

For another embodiment of the present invention, the laser ultrasonic imaging method comprises the steps of: collecting training data by irradiating a pulse laser beam to a specific point on a stationary state of the rotating object with known coordinates and by collecting the ultrasonic signals as training data using an embedded sensor or a laser vibrometer;

collecting monitoring data by irradiating the pulse laser beam to points on a rotating state of the rotating object and by collecting the ultrasonic signals as monitoring data from an ultrasonic sensor; and

estimating ultrasonic position and visualizing laser ultrasonic image by analyzing correlations between the training data set and the monitoring data set.

For a preferred embodiment of the present invention, the step of collecting training data additionally includes a step in which the step of collecting training data is repeated over the entire training grids by scanning the irradiating laser beam and measuring the training signals from the ultrasonic sensor until the full training data set completion, and the step of collecting monitoring data includes a step in which the step of collecting monitoring data is repeated over the entire monitoring grids by scanning the irradiating laser beam and measuring the monitoring signals from the ultrasonic sensor until the full monitoring data set completion. With data sets of steps, the ultrasonic generation point of each monitoring data is identified as the ultrasonic generation point of the training data which its correlation index with the monitoring data has the maximum value.

For another embodiment of the present invention, a method for estimating structural health of a rotating body comprises, a laser irradiating step by irradiating a laser beam to several positions of the rotating body, an ultrasonic measurement step measuring an ultrasonic signal at a specific point away from the laser beam irradiating point, an ultrasonic image processing step constructing a propagating signal image from the measured ultrasonic data using the reciprocal theorem, a damage visualizing step visualizing a damage for the emphasis of the damage region using standing wave filter and an information providing step which automatically gives information of the damage existence, its location and its severity by computing the energy of standing wave components trapped inside the damage and by comparing its value with the reference value.

For another embodiment of the present invention, a damage monitoring system of a rotating body comprises a pulse laser which generates an ultrasonic signal by irradiating laser beam to a position of the rotating body and an ultrasonic sensor which detects a generated ultrasonic signal at a position away from the laser irradiating position.

For another embodiment of the present invention, the ultrasonic sensor is a piezoelectric sensor mounted on the rotating body, a wireless piezoelectric sensor node mounted on the rotating body, or a noncontact laser interferometer.

### Advantageous Effects

The present invention is to automatically provide the location, the size, and the severity of damages in rotating objects such as a turbine blade, propellers of helicopters, airplanes, and ship engines. Since the present invention provides easy and intuitive finding method of local damages in rotating objects, field maintenance labors can perform an efficient management in the damage control of rotating objects.

The present invention uses a laser scanning technique for the damage detection of a rotating object, which is able to produce the high resolution ultrasonic images. Since it is possible to detect a small defect sensitively, the technique has advantage for the early monitoring of damage occurrence and for less or no sensor installations compared to the previous inventions.

As the present invention provides not only real time monitoring without the stop of a rotating objects but also the automated damage finding algorithm, the structural health monitoring can be done with the efficient and high reliability.

The present invention can reduce maintenance cost by applying the remote safety monitoring efficiently on the hard reaching rotating objects such as an ocean wind power plant complex.

### DESCRIPTION OF DRAWINGS

FIG. 1 illustrates an ultrasonic generation system on the wind blade according to the present invention.

FIG. 2 illustrates an ultrasonic measurement system in the blade with embedded sensors as an embodiment according to the present invention.

FIG. 3 illustrates an ultrasonic measurement system with a laser vibrometer as an embodiment according to the present invention.

FIG. 4 illustrates a diagram of an integrated single structural health monitoring system as an embodiment according to the present invention.

FIG. 5 shows a technique of the visualization of impact position confirmation according to the present invention.

FIG. 6 shows experimental results of the present invention. The visualized data are acquired under non-rotating condition (FIG. 6(a)), 20 rpm rotating condition according to the prior art (FIG. 6(b)) and 20 rpm rotating condition (FIG. 6(c)) according to the present invention.

FIG. 7 shows visualization results of a damage location from ultrasonic measurements according to the present invention.

FIG. 8 shows a visualization result of damage information only extracted from ultrasonic measurements according to the present invention.

### BEST MODE OF THE PRESENT INVENTION

The present invention relating a structural health monitoring system of a rotating object comprises, an ultrasonic generation system generating an ultrasonic signal by irradiating a pulse laser beam to a point of a rotating object, the pulse laser control system adjusting the irradiating time of the pulse laser beam, an ultrasonic measurement system measuring a generated ultrasonic signal at positions away from the laser irradiating position of the rotating object and a damage detection system providing information of the damage existence, the damage location and the damage severity by visualization of measured ultrasonic signals.

### Mode of the Present Invention

Hereinafter, exemplary embodiments of the present invention will be described with drawings. In each drawing of the present invention, a size is enlarged or reduced than an actual size to clarify the invention, and well known elements are omitted to emphasize a structural feature of the present invention.

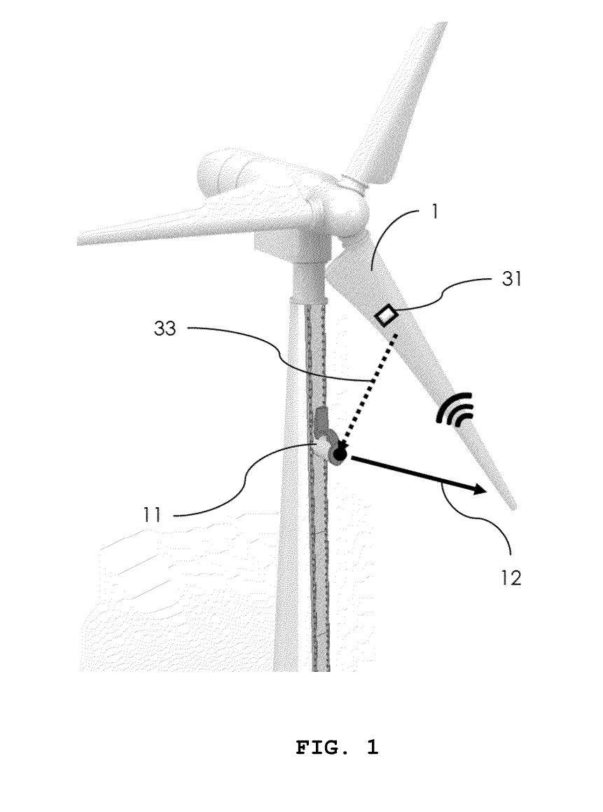

FIG. 1 illustrates, as an embodiment of the present invention, an ultrasonic generation for the structural health monitoring of a blade in a wind power generator. An ultrasonic signal is generated by irradiating laser beam (12) to a specific point of a blade (1) using a pulse laser (11). The invention as illustrated in FIG. 1 does not limit on the blade of the wind power generator but can apply on various rotating objects such as propellers of helicopters, airplanes and ship engines. A material of rotating objects may be a metal like aluminum or steel, or be a composite material like CFRP (carbon fiber reinforced plastic) or GFRP (glass fiber reinforced plastic). Technically all materials that can generate ultrasonic signal are applicable.

As a pulse laser (11) has high energy, the temperature of a laser beam irradiated local area of a rotating object is increased. Thermal energy propagates as a form of ultrasonic wave due to thermal expansion. The pulse laser is adjusted to generate the high energy just below the ablation threshold of the rotating object. An Nd-YAG pulse laser will be a preferred choice, but not be limited on it.

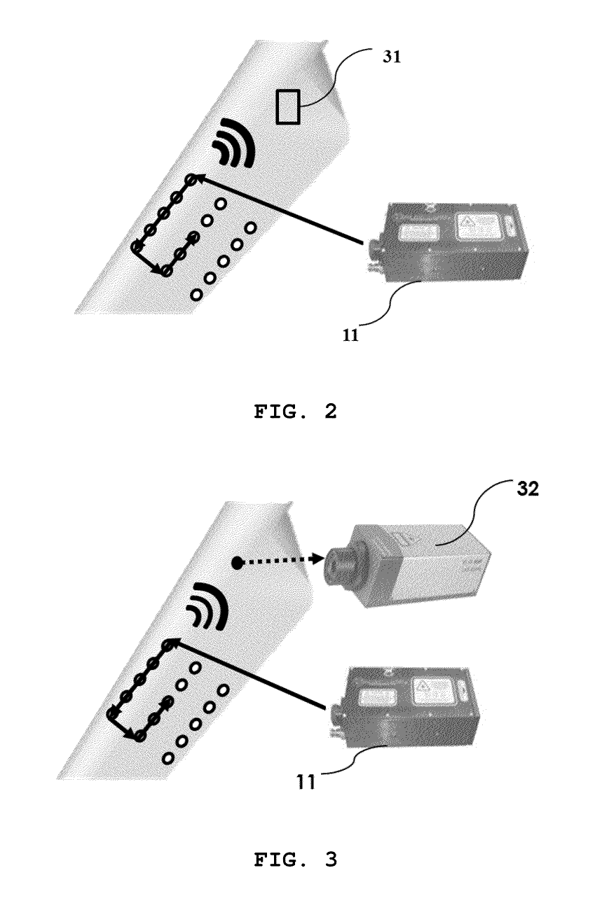

For an embodiment of the present invention, FIG. 2 illustrates the measurement of a generated ultrasonic signal using sensors embedded inside a rotating object. Embedded sensors have high SNR and very high sensitivity for the ultrasonic measurement, and the preferred one may be a high sensitivity piezoelectric sensor but is not limited on it. The usage of such sensors requires the cable installation to a rotating object for power and data transmission, which has a problem such as cable scramble. A slip ring which made of electrical conducting liquid (mercury) may be used for the electrical signal transmission at rotating units. For another embodiment of the present invention, a wireless transmitting piezoelectric sensor node may be used, which does not need to install electrical cables.

For another different embodiment of a sensor, as shown in FIG. 3, it is possible to measure the ultrasonic signal using noncontact measurement instrument such as a laser interferometer (32) instead of an embedded sensor. Examples of noncontact measurement instrument are a laser vibrometer, a two wave mixing photorefractive interferometer (TWM-PI), or a confocal Fabry-Perot interferometer (CFPI).

Generally a laser interferometer measures the phase change of light caused by the surface deformation of a structural object and is a measurement instrument of the ultrasonic signal propagating on the deformed surface and the non-deformed surface of a structure. A laser vibrometer (32) is a different form of a laser interferometer which measures the ultrasonic signal. The laser vibrometer (32) measures the surface wave velocity in a structural object using Doppler Effect which measures the change of reflected laser wavelength due to the surface vibration after irradiating a laser beam on a structural surface. A TWM-PI is a high frequency signal measurement instrument that removes low frequency using optical refractive matter in the measurement of the surface deformation change process. A CFPI is an instrument of the surface velocity measurement of a structural object that compares the wavelength change of a reflected wave by Doppler Effect with the characteristic resonance wavelength of an interferometer. A noncontact laser interferometer (32) freely determines the measurement position and does not need cables for sensor in a rotating object, compared to embedded sensor types. This gives an advantage to measure signal efficiently without affecting the structural object.

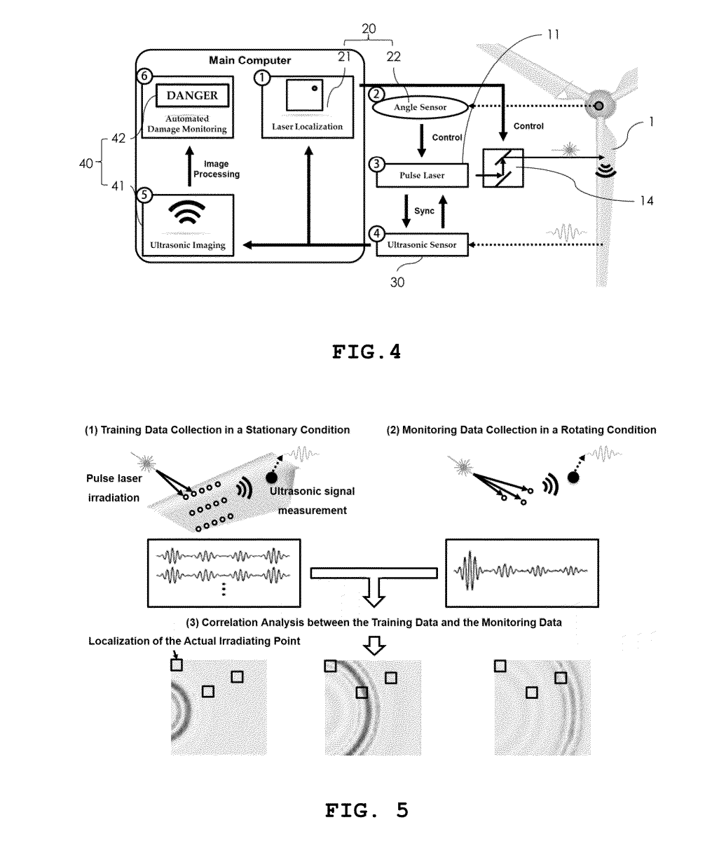

FIG. 4 illustrates a structural drawing of an integrated single structural health monitoring system. The integrated single structural health monitoring system comprises an ultrasonic generation system (10), a pulse laser control system (20), an ultrasonic measurement system (30) and a damage detection system (40).

The ultrasonic generation system (10) is to irradiating laser beam at a position of a rotating object for the generation of an ultrasonic signal. A galvanometer may be used for an exact position alignment of a pulse laser beam at a position of a rotating object where a laser beam is targeted.

The pulse laser control system (20) includes a position determination unit (21) of a main computer and an angle sensor (22). The angle sensor mounted in a rotating object makes the synchronization with a pulse laser and a laser beam can be irradiated at a specific position of the object whenever the target range comes to. This prevents from the laser beam damage of people and animals. An encoder (angle sensor) which employs an optical sensor is used for the initial position detection by detecting the generated electrical pulse signal when a object (1) rotates a round.

The ultrasonic measurement system (30) includes an ultrasonic sensor which receives an ultrasonic signal at multiple positions away from a laser beam irradiating position and a digitizer which collects signals and saves signal data. The ultrasonic sensor may be an embedded sensor or a noncontact measurement instrument such as a laser vibrometer.

The damage detection system (40) includes an ultrasonic image processing unit (41) and an automated damage detection unit. The damage detection system (40) produces images from collected data, and detects the damage from the change of propagating ultrasonic signal, and visualizes the damage information only from the image processing data, and warns a manager by an alarm, and acknowledges an early repair.

For a preferred embodiment of the present invention, a damage detection system (40) comprises, an image processing technique which extracts correlation information between ultrasonic signals and damage from ultrasonic signal data, a damage visualization technique which intuitively confirms a damage location and its severity by visualizing an extracted correlation information between an ultrasonic signal and a damage, and an automated damage monitoring technique which provides information about a confirmation of a damage and its location and its severity from extracted correlated information between ultrasonic signals and damage.

Since the ultrasonic generation position can be influenced by a form of a rotating object, wind and vibration during operation, the position is confirmed and controlled using the impact position determination technique.

FIG. 5 illustrates each step of an image processing technique by impact position determination, which finds an ultrasonic generation position using correlation information between the training data and generated ultrasonic signals. The step 1 is a process to collect training data from a stationary condition of the object. When an irradiating laser beam is irradiated to a specific point on the object with known coordinates, the corresponding signal as a training data is measured from an ultrasonic sensor or a laser vibrometer mounted on the object. This process is repeated over the entire training grids by scanning the laser beam and measuring the training signals from the ultrasonic sensor until the full training data set completion. The step 2 is a process to collect a monitoring signal data from a rotating condition of the object. This process is also repeated over the entire monitoring grids by scanning irradiating laser beam and measuring the monitoring signals from the ultrasonic sensor until the full monitoring data set completion. The accuracy position of the irradiating laser beam is obtained and evaluated by the impact position determination technique. The step 3 is a process to estimate the accuracy position of the irradiating laser beam by computing correlations between Step 1 data set and Step 2 data set and to visualize the image.

The impact position determination technique is a method to analyze correlations by comparing a monitoring signal with a training data set. Local correlation index relating the training data to a monitoring signal data has the maximum value because an ultrasonic generator and a detection mechanism are identical. Therefore, the coordinates of the training signal, which has the maximum value, are identified as the most likely laser beam irradiating point.

Let the monitoring signal f(t) and the training signal g(t), respectively. Then local correlation index between two signals is represented as a mathematical formula 1.

(f*g)(τ)=∫_{-∞}^{+∞}f(t)g(t+τ)dt Mathematical formula 1

In the mathematical formula 1, * denotes the correlation operator. The mathematical formula 1 takes a lot of computation time since it performs integration in the time domain. The computation time can be reduced by taking steps of the Fourier transformation and the inverse Fourier transformation which based on the convolution theorem and the Fourier transformation. It is represented in the mathematical formula 2 as follows and the circled multiplier is a convolution operator.

f*g=f(−t) [symbol] g=F⁻¹{Ff(−t)·F(g)} The mathematical formula 2

The image processing technique uses reciprocal theorem. The basic principle is described that a measured signal is identical with the one which is measured at the generated point after generating an ultrasonic signal at a measuring point. Then when multiple points are directed by laser beams, and a sensor at the position measures multiple ultrasonic signals, it is identical with the measured value generated from fixed ultrasonic signal source in the specific spatial region. It is also possible to generate a series of images of ultrasonic wave components by making image information of the specific spatial region and representing the results with time.

The damage visualization technique represents the information of entire time domain as a single image by computing ultrasonic wave energy at each point from the obtained ultrasonic information. Generally propagating ultrasonic waves produce standing waves at damages and then the damaged region show the high energy of ultrasonic waves. That signature is used for detecting a damage location by finding specially the region of the high energy of ultrasonic waves. The present invention uses a standing wave filter for the emphasis of damages. The standing wave filter technique is used to isolate standing wave components only trapped inside damages, which contrived by the formation of standing waves inside the damage region.

The automated damage monitoring technique automatically gives information of the damage existence and its location and its severity to a manager by communication means such as display, alarm, or SMS. The damage existence and its location and its severity are identified by computing the energy of standing wave components trapped inside the damage and by comparing its value with the reference value.

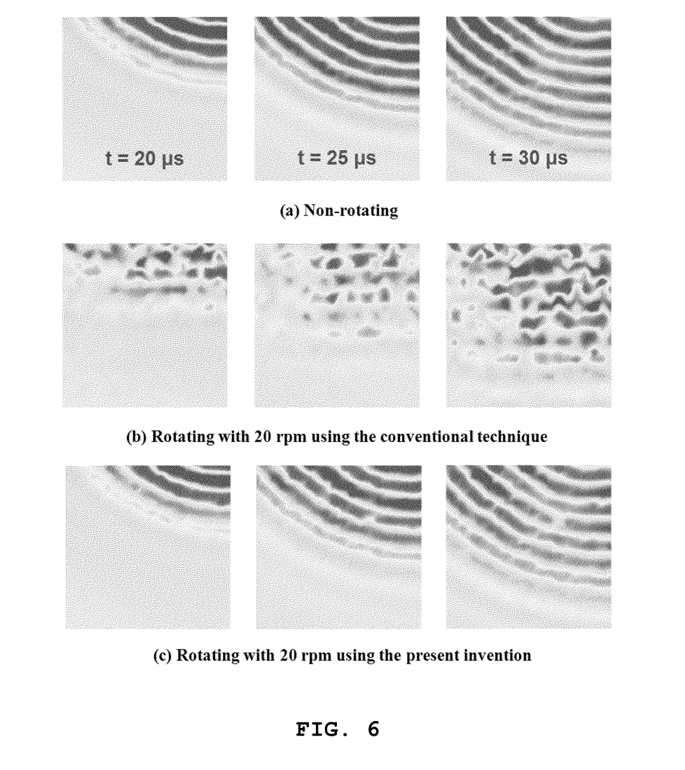

FIG. 6 represents an experimental data of the present invention. FIG. 6(a) is propagating ultrasonic images with time which are averaged from the collected ultrasonic data for 10 times laser beam irradiating at a stationary condition of the object. Stripe patterns correspond to positive and negative signal levels. Circled propagations of an ultrasonic signal indicate no damaged condition of the object. FIG. 6(b) is the propagating ultrasonic image obtained by the conventional technique, which is taken on the rotating object with 20 rpm. It does not represent the propagating ultrasonic signal because the image gets damage due to the rotating vibration and the time delay between a pulse laser and an encoder. However, FIG. 6(c) shows the accurate and clear propagating ultrasonic image of the present invention, which is obtained by the image processing technique that computes correlations between the monitoring signals and the training data set.

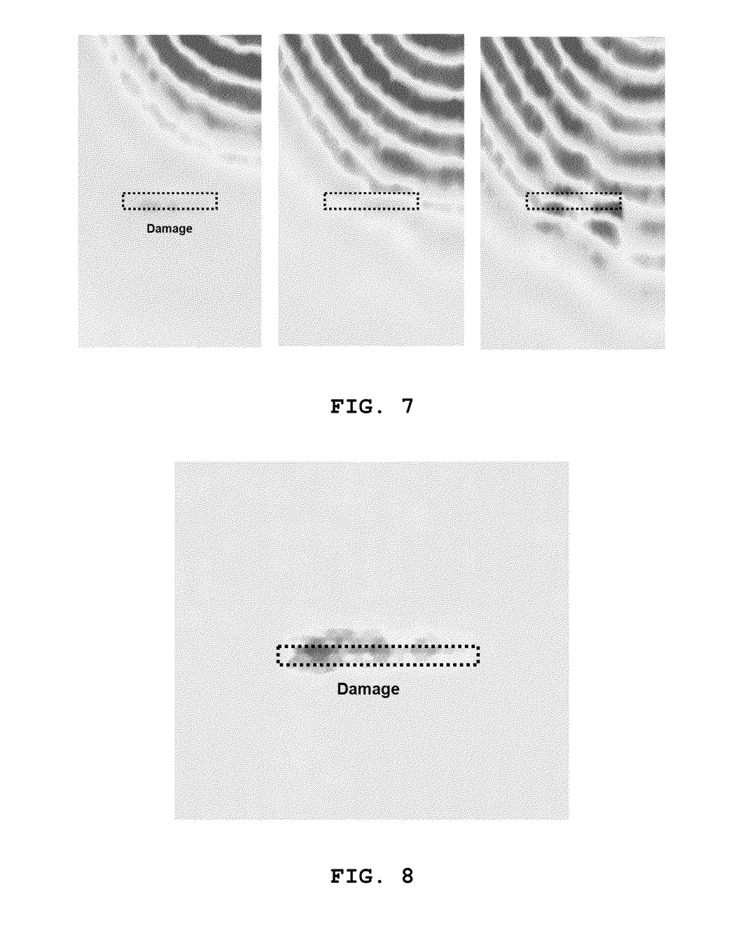

FIG. 7 shows the result obtained by an ultrasonic image processing technique of the present invention. It indicates that the propagating form of ultrasonic signal is changed due to damage of the rotating object.

FIG. 8 shows the damage information only that extracted from the image processing data using the damage visualization technique. The damage region can be identified intuitively and efficiently.

### INDUSTRIAL APPLICABILITY

The present invention is to automatically provide information of the damage location, the damage size, and the damage severity by visualization of correlation information between damage and propagating ultrasonic signals in a rotating object. The structural health monitoring of various rotating objects such as turbines, propellers of helicopters, airplanes, and ship engines can be done.

What is claimed is:

1. A structural health monitoring system for a rotating object, comprising:
an ultrasonic generation system which generates an ultrasonic signal by irradiating a pulse laser beam to a point of the rotating object;
a pulse laser control system which adjusts the irradiating time of the pulse laser beam;
an ultrasonic measurement system which measures a generated ultrasonic signal at a point of the rotating object away from the point irradiated by the pulse laser beam; and
a damage detection system which provides information of damage existence, damage location and damage severity by visualization of monitored ultrasonic signals.

2. The structural health monitoring system of claim 1, wherein the ultrasonic measurement system comprises an ultrasonic sensor which senses an ultrasonic signal and a digitizer which collects and saves monitored ultrasonic signals.

3. The structural health monitoring system of claim 2, wherein the ultrasonic sensor is an embedded sensor mounted just inside the point of the rotating object away from the point irradiated by the pulse laser beam.

4. The structural health monitoring system of claim 3, wherein the embedded sensor is a piezoelectric sensor with high sensitivity.

5. The structural health monitoring system of claim 2, wherein the ultrasonic sensor is a wireless piezoelectric sensor node.

6. The structural health monitoring system of claim 2, wherein the ultrasonic sensor is a noncontact laser interferometer.

7. The structural health monitoring system of claim 1, wherein the ultrasonic generation system includes an Nd-YAG pulse laser.

8. The structural health monitoring system of claim 1, wherein the ultrasonic generation system further comprises a galvanometer which accurately directs a pulse laser beam to the target position of the pulse laser beam.

9. The structural health monitoring system of claim 1, wherein the pulse laser control system mounts an angle sensor on an axis pole for synchronizing with the pulse laser and irradiating the laser beam only when the object comes to a target range.

10. The structural health monitoring system of claim 1, wherein the pulse laser control system includes an encoder which detects the initial position by generating electric pulse whenever the rotating object rotates each round.

11. The structural health monitoring system of claim 1, wherein the damage detection system includes an ultrasonic image processing unit which performs the image processing of obtained ultrasonic data and an automated damage detection unit which provides of information such as the damage existence, the damage location and the damage degree of the rotating object.

12. A laser ultrasonic imaging method, comprising the steps of:
collecting training data by irradiating a pulse laser beam to a specific point at a stationary state of a rotating object and collecting the ultrasonic signals as training data using an embedded sensor or a laser vibrometer;
collecting monitoring data by irradiating a pulse laser beam to points at a rotating state of the rotating object and collecting the ultrasonic signals as monitoring data from a sensor; and
estimating ultrasonic position and visualizing laser ultrasonic image by analyzing correlations between the training data set and the monitoring data set.

13. The laser ultrasonic imaging method of claim 12, wherein the training data collection step further comprises a step that the training data collection step is repeated over the entire training grids by scanning the irradiating laser beam and measuring the training signals from the ultrasonic sensor until the full training data set completion.

14. The laser ultrasonic imaging method of claim 12, wherein the monitoring data collection step further comprises a step that the monitoring data collection step is repeated over the entire monitoring grids by scanning the irradiating laser beam and measuring the monitoring signals from the ultrasonic sensor until the full monitoring data set completion

15. The laser ultrasonic imaging method of claim 12, wherein the ultrasonic generation position is to set identical when local correlation index between the training data and the monitoring data has the maximum value.

16. A method for estimating structural health of a rotating body, comprising:
a laser irradiating step irradiating laser beam to several positions of the rotating body;
an ultrasonic measurement step measuring an ultrasonic signal at specific points away from the laser irradiating position;
an ultrasonic imaging processing step making a propagating image from the measured ultrasonic data using the reciprocal theorem;
a damage visualization step visualizing damages for the emphasis of the damaged region using standing wave filter; and
an information providing step automatically providing information of the damage existence, its location, and its severity by computing the energy of standing wave components trapped inside the damage and by comparing its value with the reference value.

17. A damage monitoring system of a rotating body, comprising:
a pulse laser which generates an ultrasonic signal by irradiating laser beam to a position of the rotating body; and
an ultrasonic sensor which detects the generated ultrasonic signal at a position away from the laser irradiating position.

18. The damage monitoring system of a rotating body of claim 17, wherein the ultrasonic sensor is a piezoelectric sensor mounted on the rotating body.

19. The damage monitoring system of a rotating body of claim 17, wherein the ultrasonic sensor is a wireless piezoelectric sensor node mounted on the rotating body.

20. The damage monitoring system of a rotating body of claim 17, wherein the ultrasonic sensor is a noncontact laser interferometer.
